(19) United States
(12) Patent Application Publication
(10) Pub. No.: US 2008/0160274 A1
(43) Pub. Date: Jul. 3, 2008

(54) COEFFICIENT OF THERMAL EXPANSION ADAPTOR

(76) Inventor: Chi Hung Dang, Tucson, AZ (US)

Correspondence Address: CHI HUNG DANG, 7901 EAST HARDY STREET, TUCSON, AZ, 85750, US

(21) Appl. No.: 11/618,885

(22) Filed: Dec. 31, 2006

(51) Int. Cl. B32B 27/32; B32B 38/10

(52) U.S. Cl. 428/220; 156/153; 117/1

(57) ABSTRACT

In designing a precision monolithic structure having all discrete components with different Coefficient of Thermal Expansion (CTE) permanently bonded together, to avoid internal stress caused by changing of temperature: The Coefficient of Thermal Expansion (CTE) Adaptor must be bonded between two components having different Coefficient of Thermal Expansion (CTE); the Bonding Interfaces must be parallel; the Coefficient of Thermal Expansion (CTE) Adaptor is made of material having varied CTE, the variation must be gradual and in only one direction, which is perpendicular to the said Bonding Interfaces; at each Bonding Interface, the CTE of the CTE Adaptor must match the CTE of bonding component in certain degree.

### BACKGROUND OF THE INVENTION

1. Field of the Invention

The present invention relates to building highly precision monolithic structures comprising components with different Coefficients of Thermal Expansion (CTEs) such as optical assemblies that are highly sensitive to change of environmental temperature, shock and vibration.

2. Background of the Invention

Generally, the existing highly precision assemblies such as optical assemblies can be grouped into two categories:

### Traditional Compartmentalized Structure:

In this concept, the development process is started with the optical design of a series of discrete optics in free space, then involves the design of a metal structure to connect and align them, and finally moves to fabrication and assembly. Precision optical assemblies, especially Interferometers are very sensitive to environmental conditions. In FT-IR applications, where the Michelson configuration is widely used, the common method of assembly is to mount the mirrors and the beam splitter kinematically, using some kind of screw arrangement, on an aluminum chassis. A significant part of the assembly process is the alignment procedure involved in each assembly, where element positions must be maintained within mil-lionths of an inch and angular orientations within fractions of a second. To enable this alignment, each mirror mount is provided with an X, Y tilting mechanism. This mechanism must be able to lock the optical elements in place without distorting the exiting wavefront of the system. A common problem with this configuration is that the mirror alignment is very sensitive to vibration, shock, and slight metal fatigue conditions. It is also sensitive to changes in ambient temperature because the optical elements are usually made of glass, and the chassis is made of aluminum. These materials have very different coefficients of thermal expansion (CTEs) and conductivities.

### Linear Coefficient of Thermal Expansion for a Few Common Materials

| Material | a (m/m/°K) | a (mm/m/°K) |
|---|---|---|
| Aluminum | 23.8 × 10⁻⁶ | 0.0238 |
| Concrete | 12.0 × 10⁻⁶ | 0.011 |
| Copper | 17.6 × 10−6 | 0.0176 |
| Brass | 18.5 × 10⁻⁶ | 0.0185 |
| Steel | 12.0 × 10⁻⁶ | 0.0115 |
| Timber | 40.0 × 10⁻⁶ | 0.04 |
| Quartz Glass | 0.5 × 10⁻⁶ | 0.0005 |
| Polymeric Materials | 40-200 × 10⁻⁶ | 0.040-0.200 |
| Acrylic | 75.0 × 10⁻⁶ | 0.075 |

The assembly of optical elements and a chassis with different CTEs and conductivities would normally require a flexible member between the mirrors and the aluminum chassis. However, this requirement contradicts a more important one, that is, that the interface between the different components in the assembly be totally stiff. Various technologies have been developed to overcome this problem; nonetheless, maintaining constant alignment is a routine and costly process. To obtain a more accurate and stable interferometer, the monolithic body assembly concept was developed. In the traditional designs, stresses such as those produced by preloaded screws, ball contacts and internal dislocations in the substrate create various problems, including those associated with random relative movement, bulk geometry, birefringence and wavefront. Similarly, as two dissimilar interfaced parts go through thermal cycling, their differential expansion will cause stresses that will lead to misalignment. Monolithic design avoids these issues and further ensures long-term stability by eliminating relative part-to-part movement.

In conclusion, the Pros and Cons of Traditional Compartmentalized Structure are:

Pros:
Flexibility in optical component design.
Flexibility in optical component material.
Flexibility in frame/mounting design.
Flexibility in frame/mounting material.
Built-in adjustment and alignment fixtures.
Feasible, practical and lower cost for large aperture, long optical path design.

Cons:
Less solid structure, more sensitive to shock and vibration.
Mechanical drifting, requirement for maintenance and readjustment/realignment.

### Optically Contact Surface Bonding Monolithic Structure:

With the emergence of better optical production technologies comes a new assembly concept, monolithic design, an integrated optical solution in which individual optic elements of the same material directly bond to each other or through similar material spacers. As a result the critical alignment between elements is maintained by the parts themselves instead of by an external mechanical assembly. Great care must be taken in the fabrication aligning and bonding of the elements and spacers to achieve the required alignment; however, once successfully assembled, the monolithic structure is extremely robust, nearly impossible to misalign, much less massive, and smaller than a system employing mechanical mounts. The entire face is used in the bond since modern computer numerical control machines can manufacture higher-precision surfaces onto glass, ceramic and single-crystal than on metal. These designs require few or no metal structures; adhesion and external tooling construct the assembly. However metal or other tough ductile materials still affect design, since the assembly eventually will have an interface specifically, the outer face that connects to metal. This type of Monolithic design often relies on completely contiguous glass-to-glass bonding, this changes the optical and the coating design. The changes in coatings are not more difficult, but it should be taken into the design consideration. Some of the advantages over mechanical bonding include no slipping, less machining and lower weight. But this design concept poses several challenges, which are adhesion uncertainty, cure time, thickness uniformity, curing-induced stress, coefficient of thermal expansion mismatch, weaker bond, surface finish issues and outgassing. In high-precision applications, monolithic designs are superior because they stiffen the structure and make it more stable. In commercial products, they are attractive because they enable reduced part counts and less expensive assemblies. Pay attention to the cost and weight of glass, ceramic and single crystal: Parts made with the glass, ceramic and single crystal method are two to three times more expensive than those made with stainless steel and considerably heavier than composite material parts. However, using smaller, lighter assemblies may allow trade-offs in other parts of the system, decreasing overall product cost. As the distances between optic elements grow, the cost, weight, and ability to maintain the required tolerance of spacers become unmanageable. Furthermore, in some applications such as Infrared Interferometer with large aperture, employing optic elements and spacers, all with the same material is impractical and extremely costly; since all transmitting components such as lenses and beam splitters are fabricated Germanium that is expensive, while large mirrors and frame/mounting fixtures can be made with light weight and less expensive composite materials. Another concern is the removable adjustment and alignment fixtures concept: in this structure, monolithic optics are aligned during the bonding process; after the bond is stable, the tooling can be removed, but due to bonding process problems such as adhesion uncertainty, thickness uniformity, curing-induced stress, coefficient of thermal expansion mismatch, and weaker bond, which may cause mechanical drifting after bonding process when the tooling is removed.

In conclusion, the Pros and Cons of Optically Contact Surface Bonding Monolithic Structure are:

Pros:
Solid structure, less sensitive to shock and vibration.
Minimum mechanical drifting, no requirement for maintenance and readjustment/realignment.
Compact packaging.

Cons:
Less flexibility in optical component design.
Less flexibility in optical component material.
Less flexibility in frame/mounting design.
Less flexibility in frame/mounting material.
Removable adjustment and alignment fixtures that may cause mechanical drifting after bonding process.
Less feasible, impractical and higher cost for large aperture, long optical path assemblies.

This invention proposes the utilization of thermal expansion adapter material having varied coefficient of thermal expansion at different points within the adaptor structure, which will mitigate all the cons while retaining all the pros of both above structures. The design paradigm of this concept comprises:

The use of permanent bonding between all components to create a monolithic assembly: As definition, a monolithic structure forms a single body; permanent bonding between several elements meets this criterion. There are several existing bonding techniques, as described by the following excerpts from U.S. Pat. No. 5,846,638:
“Organic Adhesives: Organic adhesives such as epoxies and polyimides are the most common means of securing bonds between similar or dissimilar materials. While these adhesives have been applied to a variety of devices, including solid state laser systems, they suffer from numerous disadvantages. First, they tend to gradually decompose when they are subjected to intense laser radiation. Therefore their usefulness may be limited to applications requiring a single or at most a few bursts of laser radiation, for example such applications as laser-initiated explosive ordnance. They are not practical when long-term reliability is an important requirement for economic viability of a laser device. Second, there usually exists a difference in refractive index between the organic adhesive and the components to be bonded. It is normally impossible to overcome this difference since the indices of organic adhesives are rarely available beyond an index of 1.6 while many of the crystals to be bonded have significantly higher indices. Third, organic adhesives generally have poor thermal and mechanical properties thus making them poor candidates for components requiring high reliability. Fourth, organic adhesives are usually prone to outgassing, especially when evacuated or when heated, thus leading to performance deterioration due to contamination.
Inorganic Frits and Glasses: Another technology for bonding and/or sealing similar or dissimilar materials employs inorganic low-melting temperature glasses either as powders suspended in inorganic or organic vehicles or as readily applicable preform sheets. Different thermal expansions and refractive indices are available for obtaining a certain degree of matching between the properties of the frit and those of the components to be bonded, thus providing at least limited utility. Examples of this type of bond include hermetic sealing of semiconductor devices and graded expansion seals between metal-glass joints.
Brazed or Metal-Sealed Joints: A third type of bonding technique utilizes metals deposited from the vapor phase or mixtures of metals with glass frits. The bonding material is applied to the components to be joined, such as high temperature ceramics, which can then be soldered together. This technique is clearly only useful for those applications where the presence of metal at the interface is not objectionable, thus generally ruling out components which require optical transmission across the interface. Electrical insulation and dielectric properties also are compromised by the presence of metal within the bond. Hermetic seals are achievable using this technique.
Diffusion Bonding: Ceramic components are frequently bonded with an intermediate layer of lower temperature metal which will diffuse into the adjacent components and generate a bond. While this bond has utility for ceramic bonding, it is of little use for electro-optical precision components.
Vapor Deposition: The evident disadvantages of adhesive layers has resulted in intensified efforts to find a technique which either eliminates or at least minimizes the bonding agent. Vapor deposition represents one technique of depositing one or more layers, each layer being approximately a micron thick. These layers can be formed from metals, carbon-containing compounds, and inorganic compounds such as oxides, fluorides or chalcogenides. Thicker layers can be deposited by sputtering.
Glass Lamination: A technique which can be used with glasses for a few specific applications is that of glass lamination. In this technique molten sheets of glass are laminated at high temperatures by an elaborate process in which molten glass exits slit-shaped orifices and is subsequently pressed together. The joining process occurs at temperatures well above the glass transition temperature. This process is not only impossible to apply to a variety of glasses, it is simply impractical for many specialized applications primarily due to the high working temperatures.
Fusion Splicing: The technique of fusion splicing of optical fibers has enjoyed relative success, especially in the arena of optical communication. Currently optical fibers can be fused together resulting in a relatively low optical loss bond. Unfortunately this technique has not proven to be as successful with optical fibers used to transmit high power laser radiation. For this application even minor defects such as those commonly associated with fusion splicing will result in unacceptable levels of absorption and scatter, potentially leading to catastrophic failure of the bond. A further problem associated with fusion splicing is that this technique is restricted to joining fibers of the same or similar chemical composition, such as silica-based fibers with other silica-based fiber ends. Inputs and outputs of optical fibers from electro-optical devices have to be joined by methods which are fraught with disadvantages, typically resulting in unacceptable loss levels at the device interface.
Anodic Bonding: Anodic bonding is a technique utilizing electrostatic fields to irreversibly join planar surfaces of electrically conducting materials with electrically insulating materials. Anodic bonding is extensively employed for bonding semiconductor wafers, specifically silicon wafers, with borosilicate glass. The primary applications are to seal the silicon structure underneath and to provide an insulating interlayer between two silicon wafers bonded together. Strong, hermetic seals can be obtained at relatively low temperatures, between 300 and 6500° C., thereby preventing damage to previously applied metallizations and structures. Electrode design, thermal chuck design, and thermal expansion coefficients are critical parameters for the success of anodic bonding.
Fusion Bonding: Polished silicon wafers contain a thin hydroxyl layer, effectively resulting in a hydrophilic surface. Adhesion by hydrogen bonding begins when two wafers come in contact with each other. Mechanical bond stability increases with further heat treatment. The hydroxyl groups initially rearrange to form bonds of higher stability, decreasing the separation between the adjoining surfaces. Gradually the bonds undergo condensation reactions, resulting in silicon-oxygen-silicon bonds between the wafers. The released water is removed by diffusion from the bond interface through the silicon network and the gap between the components. Exposure to higher temperatures result in even stronger silicon-silicon bonds. This technique of wafer bonding is essentially restricted to areas of the order microns. This may be sufficient for certain research applications but is not practical for a production of electro-optical devices. Thus when this technique is applied to large wafer areas, typically the overall contact area between the wafers is a composite of bonded areas and unbonded areas. The transition between the bonded and unbonded areas represents an area of partial bonding of somewhat reduced adhesion, the adhesion characteristics being a function of specific location. This results in the composites mechanical, electro-optical, optical and thermal properties being dependent on location.
Diffusion bonding: In the prior art method of diffusion bonding, adjacent surfaces are brought into close contact under pressure and heated in an appropriate atmosphere to allow diffusion across the interface. While it may initially appear that the application of pressure would alleviate problems with defects at the interface, it is likely to have the unintended adverse effect of prematurely trapping gas in the interface area by sealing it in before it can escape. When this technique is used with single crystal wafers and at temperatures which are insufficient to allow plastic deformation, the applied pressure can generate micro-cracks. If the processing temperature is raised sufficiently to prevent micro-cracks, the plastic deformation of the wafers will disturb the crystal structure.
Wringing: U.S. Pat. No. 4,810,318 discloses a technique of bonding in which two components such as glass, quartz or silicon are joined with at least one layer of polycrystalline material. Typically the layer is an electro-optically active layer such as TiO.sub.2, MgF.sub.2, Al.sub.2 O.sub.3, Ga.sub.2 O.sub.3, HfO.sub.2, ZnS, BaTiO.sub.3, or Y.sub.3 Fe.sub.5 O.sub.12 which has been deposited by vapor deposition or sputtering. The disclosed method requires that the components undergo a slight polishing treatment, preferably with cerium powder, for less than a minute to activate the surfaces to be bonded to create a “fresh” surface. The prepared component surfaces are brought into contact by wringing. No heat treatment is applied. Wringing as a means of providing intimate contact between two components is extensively employed in the course of precision machining or measurements to temporarily join gauge blocks of tool steel, WC or ZrO.sub.2 ceramics with flat surfaces, usually with the aid of a thin layer of mineral oil to improve sliding of the two blocks on each other. This is discussed on page 136 of Foundations of Mechanical Accuracy, The Moore Special Tool Company (1970). obviously wrung-in-contact gauge blocks do not need to provide an optical quality interface free of scattering imperfections. Since the techniques disclosed in U.S. Pat. No. 4,810,318 would not be sufficient to eliminate such defects as gas or particulates, the resultant interface would not be a low scatter interface. Therefore this technique is limited to joining components which are not sensitive to scatter at the interface.
Mechanical Contacting: EPA Patent No. 0 209 173 discloses a process of contacting optically smooth surfaces of semiconductors or of optically or magnetically active materials with each other in a dust-free atmosphere in order to obtain a mechanical connection, after which they are subjected to a heat treatment of at least 300.degree. C. The invention discloses subjecting the components to be contacted to a bond-activating treatment which removes surface microscopic irregularities. The disclosed treatment consists of a light surface smoothing and/or chemical etching. The patent also cites the deposition of a layer of wet spin coating followed by the removal of the organic constituents by heat treatment to at least 800.degree. C. as another bond-activating treatment. The method of contacting activated surfaces disclosed in EPA Patent No. 0 209 173 s not provide the necessary control required for reproducible fabrication of semiconductor or electro-optical devices. This method emphasizes the establishment of a mechanical bond without considering interface defects or how to overcome them. Large areas of non-bonded surfaces are generally part of such a bonding treatment since bonding occurs at first contact of the surfaces. The alternative use of spin coating as a bond-activating treatment not only results in gas entrapment but also tends to modify the physical properties of the components at the bond interface. Additionally, heat treatment of the spin coated surfaces results in glass formation with microscopic mud cracks which reduce surface smoothness and result in reduced contact between adjacent surfaces.
Optical Contacting: Optical contacting has long been known and employed in the fabrication of optical components such as cuvettes of fused quartz for spectroscopy. This technique is capable of providing a bond of high optical quality without defects at the interface and therefore, without scattering losses. The bond exhibits nominal strength at room temperature. The bond is believed to be established predominantly by hydrogen bonding across the interface. While the bond can withstand short exposures to aqueous or non-aqueous solvents, it usually debonds by diffusion of aqueous or non-aqueous solvent or detergent into the interface from the edge which constitutes the bond line between the components in optical contact. This results in instability of the bonded components which can lead to complete bond failure unless the bond line has been sealed. Even if the bond is sealed, it is inadequate for devices where reliable, permanent bonds between components of well-defined interface properties are required.
Optical Contacting and Subsequent Heat Treatment: U.S. Pat. No. 5,441,803 copending application Ser. Nos. 330,174 08/339,147, h incorporated herein by reference for all purposes, disclose the use of optical contacting in conjunction with a subsequent heat treatment.
U.S. Pat. No. 5,846,638: provides a method of forming defect-free permanent bonds without the use of adhesives as well as devices formed by this method. In general, the disclosed process allows similar or dissimilar crystalline, vitreous or dense polycrystalline ceramic, metallic or organic polymeric components to be first joined by optical contacting and then heat treated to stabilize the bond.

The heat treatment can be performed at a low enough temperature to prevent interdiffusion between species, thus insuring that the bond is not subjected to excessive mechanical stresses and that the materials do not undergo phase changes. Therefore this technique allows stable bonds to be formed between materials of widely differing physical, mechanical, thermal, optical and electro-optical properties such as different hardness, chemical durability, mechanical strength, coefficients of thermal expansion, thermal conductivity, crystal structure, refractive indices, optical birefringence, nonlinear optical coefficients, electrical conductivity, or semiconducting properties.”

The use of adaptor fixture made of material having varied coefficient of thermal expansion and conductivity: In this concept, two components with different CTEs are interconnected by an CTE adaptor having CTE gradually varied in one direction, which is perpendicular to the flat interfacing planes between the CTE adaptor and the two said components; at each interface, the CTE adaptor has CTE that matches to the adjacent component CTE in certain degree.

Allowing the freedom of material selection for each individual component to obtain best performance, cost, and reliability: With this concept, components can be optimally selected based on function, reliability, cost, manufacturability, weight, adaptation, integration and other parameters.

The use of Optically Contact Surface Bonding Monolithic Structure: This concept is still viable when it is applicable and provides the most optimum solution.

The use of removable adjustment and alignment fixtures: This concept is desirable when the bonding process is predictable and the bond remains stable after the alignment fixture is removed.

The use of built-in adjustment and alignment fixtures: In this concept, the adjustment fixtures preferably made of the same material of the components are bonded to the assembly during the aligning and bonding process.

The proposed concept of this invention is not only applicable to precision monolithic optical assemblies, but to any monolithic structure comprising component with different Coefficient of Thermal Expansion.

### SUMMARY OF THE INVENTION AND OBJECTS

The proposed concept comprises the use of adaptor fixture made of material having varied coefficient of thermal expansion and conductivity: Two bodies with different CTEs are interconnected by an CTE adaptor having CTE gradually varied in one direction, which is perpendicular to the flat interfacing planes between the CTE adaptor and the two said bodies; at each interface, the CTE adaptor has CTE that matches to the body CTE in certain degree.

Coefficient of Thermal Expansion (CTE) Adaptor material comprises multi-thin composite material layers, each has a CTE slightly different from its two adjacent layers (or layer at the top and bottom surfaces). All said layers are bond together to form a Coefficient of Thermal Expansion (CTE) Adaptor material having CTE gradually varied in only one direction, which is perpendicular to the said Bonding Interfaces.

These are two proposed techniques to produce the materials:

Bonding technique: Individual thin layers are fabricated with composite material; each has slightly different composition from others to obtain slightly different CTE. The layers are then bonded together in specific order to form a Coefficient of Thermal Expansion (CTE) Adaptor material having CTE gradually varied in only one direction, which is perpendicular to the said Bonding Interfaces.

Vapor deposition technique: Individual thin layer is fabricated with composite material; each has slightly different composition from others to obtain slightly different CTE and the subsequent layer is sputtered directly on top of the previously sputtered adjacent layer in a specific order to form a Coefficient of Thermal Expansion (CTE) Adaptor material having CTE gradually varied in only one direction, which is perpendicular to the said Bonding Interfaces.

The object of this invention is to provide the Thermal Expansion (CTE) Adaptor concept in building highly precision monolithic structures comprising components having different Coefficients of Thermal Expansion (CTEs) such as optical assemblies that are highly sensitive to change of environmental temperature, shock and vibration. Other objects are to provide the preferred makeups of the Thermal Expansion (CTE) Adaptor Material and fabrication techniques of said materials.

These and other objects and advantages of this invention will become apparent through examining the following description of the arrangement, operations and functionalities of the constituent components and appended claims in conjunction with the attached drawings.

### BRIEF DESCRIPTION OF THE DRAWINGS

FIG. 1 shows an isometric view of a schematic partial illustration of a precision optical monolithic structure comprising three lens assemblies, four spacers, two beam benders and eight Coefficient of Thermal Expansion (CTE) Adaptors.

FIG. 2 shows a side cutout view of a schematic partial illustration of the precision optical monolithic structure shown FIG. 1.

FIG. 3 shows a top cutout view of a schematic partial illustration of the precision optical monolithic structure shown FIG. 1.

FIG. 4 shows a front cutout view of a schematic partial illustration of the precision optical monolithic structure shown FIG. 1.

FIG. 5, and FIG. 6 show different isometric views of a schematic partial illustrating a more practical construction for the same assembly of FIG. 1 wherein all optic components and assemblies are bonded to a solid and tough single body enclosure with removed top cover.

### DETAILED DESCRIPTION OF THE INVENTION

In designing a monolithic structure having all discrete bodies with different Coefficient of Thermal Expansion (CTE) permanently bonded together, the following principles must be followed to avoid internal stress caused by changing of temperature:

Bodies having identical Coefficient of Thermal Expansion (CTE) may be directly bonded together

The Coefficient of Thermal Expansion (CTE) Adaptor must be bonded between two bodies having different Coefficient of Thermal Expansion (CTE).

The Bonding Interfaces (the interconnection interfaces) must be parallel.

The Coefficient of Thermal Expansion (CTE) Adaptor is made of material having varied CTE, the variation must be gradual and in only one direction, which is perpendicular to the said Bonding Interfaces.

At each Bonding Interface, the CTE of the CTE Adaptor must match the CTE of bonding body in certain degree to avoid built up internal stress due to temperature variation.

The real world is almost always more complex: The CTE can vary with temperature, so that the amount of expansion not only depends upon the temperature change but also upon the absolute temperature of the material. Some materials are not isotropic and have a different value for the coefficient of linear expansion dependent upon the axis along which the expansion is measured. For instance, with increasing temperature, calcite (CaCO₃) crystals expand along one crystal axis and contract along another axis. In some applications, it is desirable to have the Coefficient of Thermal Expansion (CTE) Adaptor made of non-isotropic material, which has near zero CTE directional component in direction perpendicular to the Bonding Interfaces while CTE directional components in directions parallel to the Bonding Interfaces still gradually varied in the direction perpendicular to the said Bonding Interfaces; at each Bonding Interface, the CTE directional components of the Coefficient of Thermal Expansion (CTE) Adaptor only needs to match the CTE directional components of the adjacent body in all directions parallel to the Bonding Interfaces.

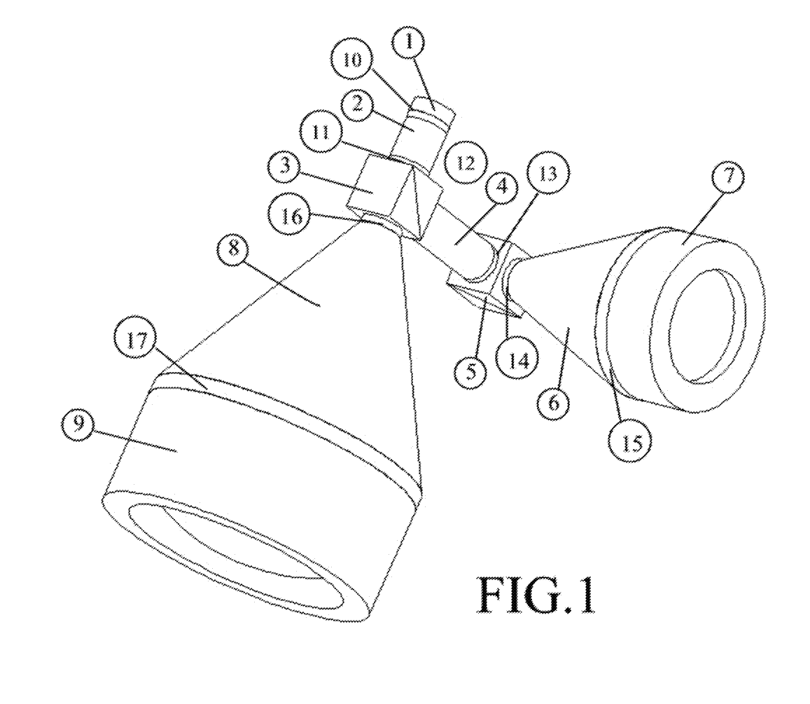

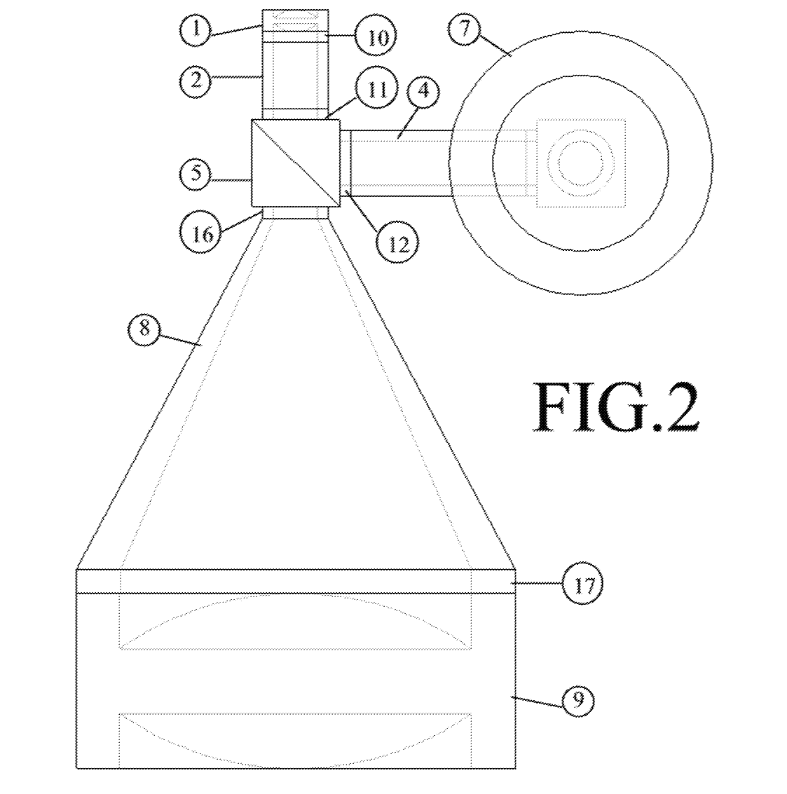

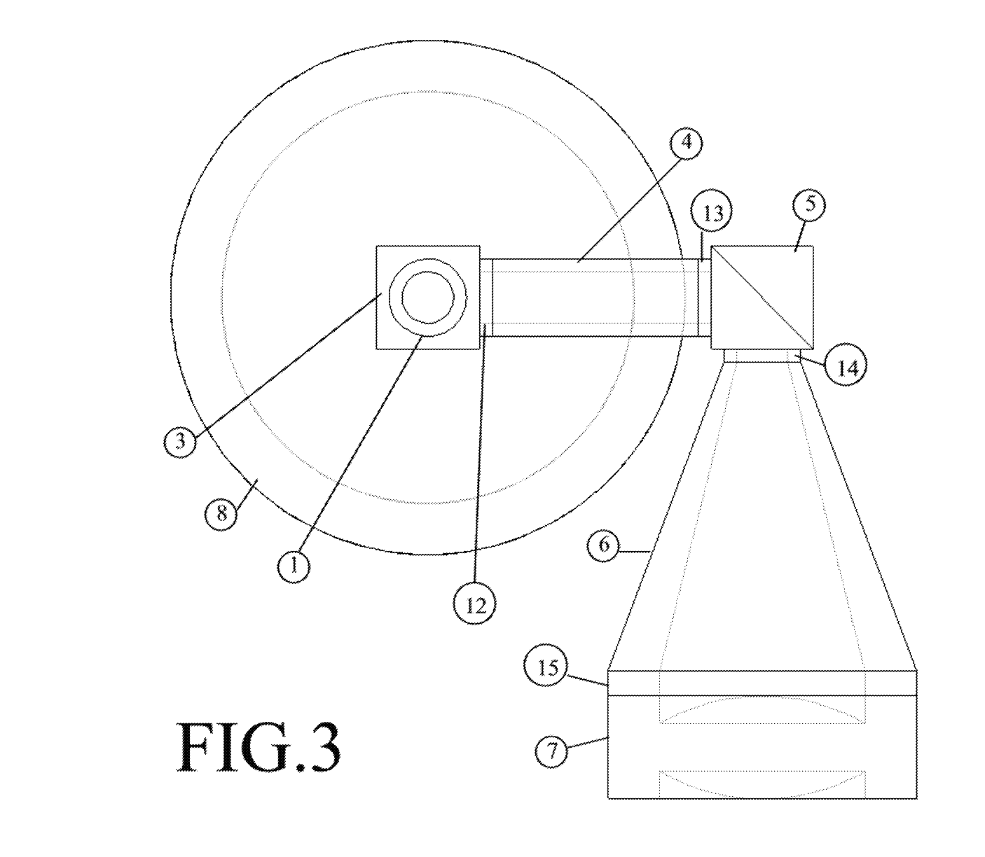

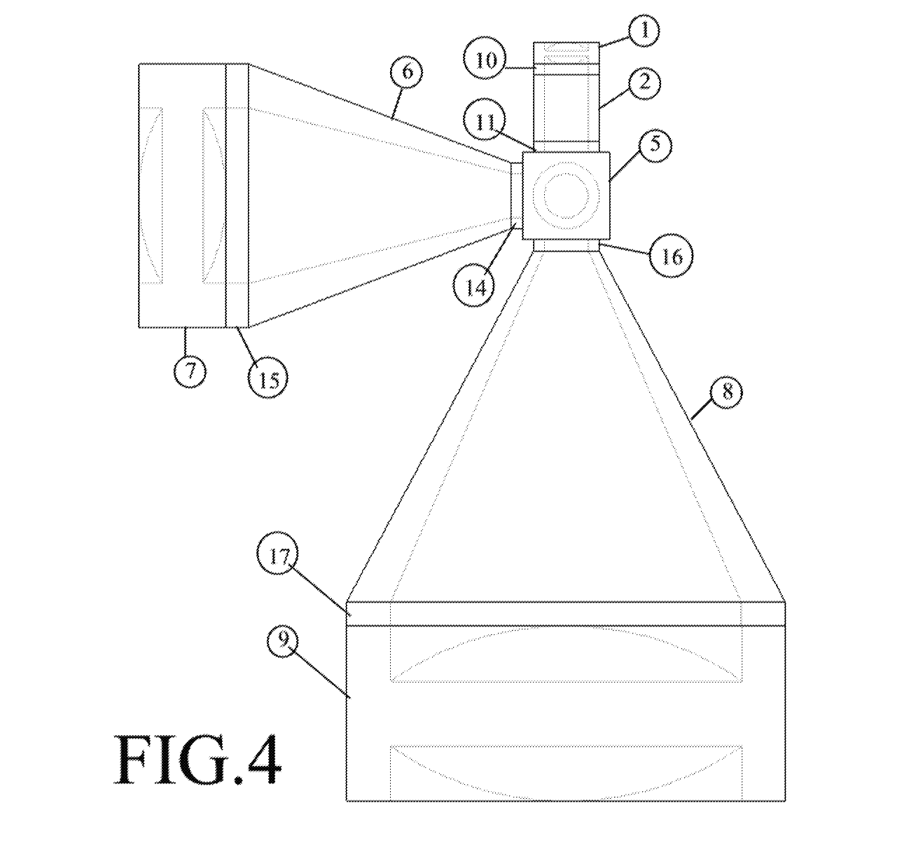

Example of a monolithic structure following these principles is illustrated in FIG. 1, and FIG. 2, FIG. 3, and FIG. 4. This structure does not posses the up-most solid and stable body since it is designed only to illustrate the application of the Thermal Expansion (CTE) Adaptor.

FIG. 1 shows an isometric view of a schematic partial illustration of a precision optical monolithic structure comprising:

A lens assembly 1 having Coefficient of Thermal Expansion (CTE) value of CTE1;

A spacer 2 having Coefficient of Thermal Expansion (CTE) value of CTE2;

A beam bender/splitter 3 having Coefficient of Thermal Expansion (CTE) value of CTE3;

A spacer 4 having Coefficient of Thermal Expansion (CTE) value of CTE4;

A beam bender/splitter 5 having Coefficient of Thermal Expansion (CTE) value of CTE5;

A spacer 6 having Coefficient of Thermal Expansion (CTE) value of CTE6;

A lens assembly 7 having Coefficient of Thermal Expansion (CTE) value of CTE7;

A spacer 8 having Coefficient of Thermal Expansion (CTE) value of CTE8;

A lens assembly 9 having Coefficient of Thermal Expansion (CTE) value of CTE9;

A Coefficient of Thermal Expansion (CTE) Adaptor 10 that interconnects the lens assembly 1 to the spacer 2 has CTE gradually varied from CTE1 at its interface with the Lens assembly 1 to CTE2 at its interface with the spacer 2.

A Coefficient of Thermal Expansion (CTE) Adaptor 11 that interconnects the spacer 2 to the beam bender/splitter 3 has CTE gradually varied from CTE2 at its interface with the spacer 2 to CTE3 at its interface with the beam bender/splitter 3.

A Coefficient of Thermal Expansion (CTE) Adaptor 12 that interconnects the beam bender/splitter 3 to the spacer 4 has CTE gradually varied from CTE3 at its interface with the beam bender/splitter 3 to CTE4 at its interface with the spacer 4.

A Coefficient of Thermal Expansion (CTE) Adaptor 13 that interconnects the spacer 4 to the beam bender/splitter 5 has CTE gradually varied from CTE4 at its interface with the spacer 4 to CTE5 at its interface with the beam bender/splitter 5.

A Coefficient of Thermal Expansion (CTE) Adaptor 14 that interconnects the beam bender/splitter 5 to the spacer 6 has CTE gradually varied from CTE5 at its interface with the beam bender/splitter 5 to CTE6 at its interface with the spacer 6.

A Coefficient of Thermal Expansion (CTE) Adaptor 15 that interconnects the spacer 6 to the lens assembly 7 has CTE gradually varied from CTE6 at its interface with the spacer 6 to CTE7 at its interface with the lens assembly 7.

A Coefficient of Thermal Expansion (CTE) Adaptor 16 that interconnects the beam bender 3 to the spacer 8 has CTE gradually varied from CTE3 at its interface with the beam bender 3 to CTE8 at its interface with the spacer 8.

A Coefficient of Thermal Expansion (CTE) Adaptor 17 that interconnects the spacer 8 to the lens assembly 9 has CTE gradually varied from CTE8 at its interface with the spacer 8 to CTE9 at its interface with the lens assembly 9.

FIG. 2, FIG. 3, and FIG. 4 show side, top, and front cutout views of a schematic partial illustration of the precision optical monolithic structure shown FIG. 1.

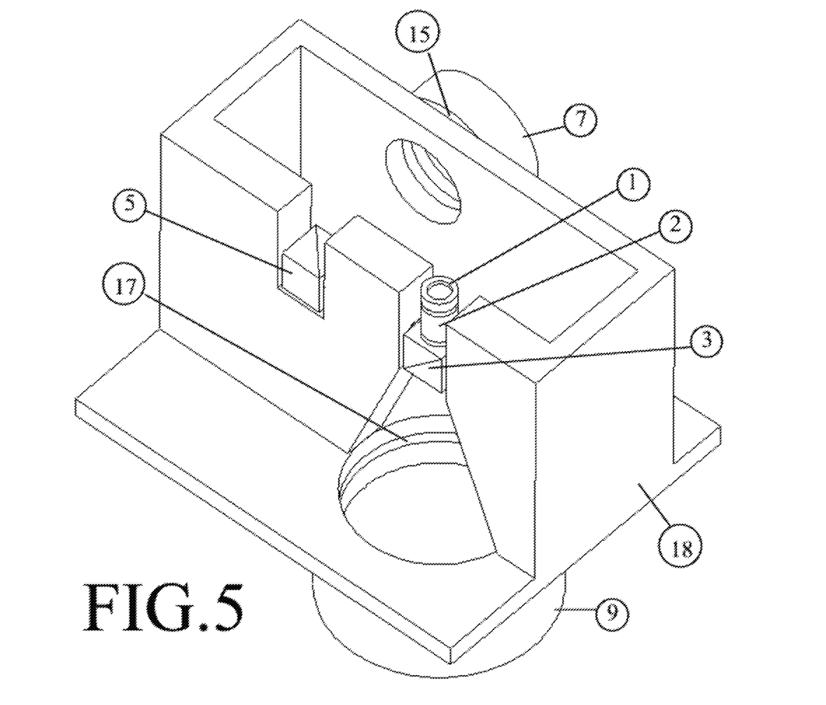

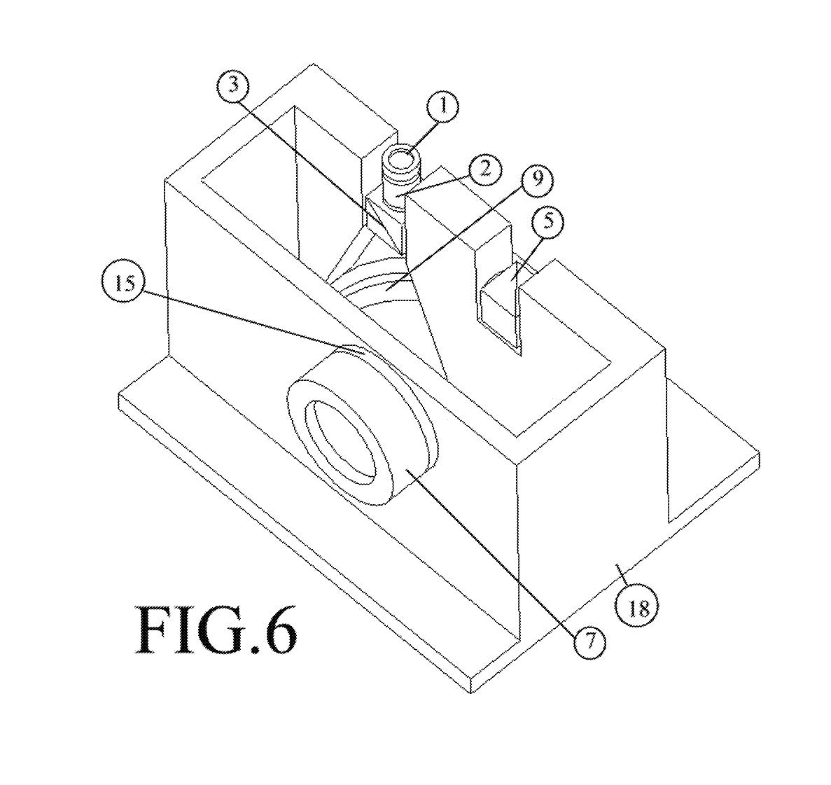

FIG. 5, and FIG. 6 illustrate a more practical construction for the same assembly of FIG. 1 wherein all optic components and assemblies are bonded to a solid and tough single body enclosure 18 made of lightweight composite material (such as carbon fiber composite having near zero CTE or Alloy Composite):

directly if components have identical CTE to that of the enclosure. Reflective components such as mirrors can fabricated with the same material of the enclosure.

or via Coefficient of Thermal Expansion (CTE) Adaptor.

Preferred Frame and Spacer material:

Advanced composites utilize a combination of resins and fibers, customarily carbon/graphite, kevlar, or fiberglass with an epoxy resin. The fibers provide the high stiffness, while the surrounding polymer resin matrix holds the structure together. The fundamental design concept of composites is that the bulk phase accepts the load over a large surface area, and transfers it to the reinforcement material, which can carry a greater load. The significance here lies in that there are numerous matrix materials and as many fiber types, which can be combined in countless ways to produce just the desired properties. These materials were first developed for use in the aerospace industry because for certain applications they have a higher stiffness to weight or strength-to-weight ratio than metals. This means metal parts can be replaced with lighter weight parts manufactured from advanced composites. Generally, carbon-epoxy composites are two-thirds the weight of aluminum, and two and a half time as stiff. Composites are resistant to fatigue damage and harsh environments, and are repairable. Metal Matrix or Alloy Composite material such as Albite Particle in Al6061 having high wear resistance, dimensional stability, thermal conductivity and low CTE is good candidate for frame/part material; furthermore, its CTE can be tailored by varying the Albite composition, this Particulate-Reinforced composite can be utilized as Coefficient of Thermal Expansion (CTE) Adaptor material.

### Preferred Coefficient of Thermal Expansion (CTE) Adaptor Material:

Its has been shown that the advanced composite materials, which can be obtained by either simple pressing of the powders (metal, ceramic, polymer) and sintering or by a wet-chemical sol-gel process are well suited for stable space structures due to their low Coefficient of Thermal Expansion (CTE), high stiffness and light weight. For a given design application, composite hardware can be tailored for strength, stiffness, CTE, and Coefficient of Moisture Expansion (CME). The Particulate-Reinforced composites, which not only have high specific strengths and modulus at room and elevated temperatures but also have excellent wear resistance, high thermal conductivity, low thermal expansion and good dimensional stability can be a great candidate for the Coefficient of Thermal Expansion (CTE) Adaptor material; especially since its elastic modulus and CTE may be tailored by varying the ceramic particle content in the matrix.

The sol-gel process is a process for making glass/ceramic materials. The sol-gel process involves the transition of a system from a liquid (the “sol”) into a solid (the “gel”) phase. The sol-gel process allows the fabrication of materials with a large variety of properties: ultra-fine powders, monolithic ceramics and glasses, ceramic fibers, inorganic membranes, thin film coatings and aerogels. The sol is made of solid particles of a diameter of few hundred nm, usually inorganic metal salt suspended in a liquid phase. In a typical sol-gel process, the precursor is subjected to a series of hydrolysis and polymerization reactions to form a colloidal suspension, then the particles condense in a new phase, the gel, in which a solid macromolecule is immersed in a solvent.

In practice, the Coefficient of Thermal Expansion (CTE) Adaptor material comprises multi-thin composite material layers, each has a CTE slight different from its two adjacent layers (or layer at the top and bottom surfaces). All said layers are bonded together to form a Coefficient of Thermal Expansion (CTE) Adaptor material having CTE gradually varied in only one direction, which is perpendicular to the said Bonding Interfaces. These are two proposed techniques to produce the materials:

Bonding technique: In practical manufacturing processes, the Coefficient of Thermal Expansion (CTE) Adaptor material can be produced by the following concepts: Individual thin layer is fabricated with composite material; each has slightly different composition from others to obtain slightly different CTE. The layers are then bonded together in specific order to form a Coefficient of Thermal Expansion (CTE) Adaptor material having CTE gradually varied in only one direction, which is perpendicular to the said Bonding Interfaces. Each layer can be produced by either simple pressing of the powders (metal, ceramic, polymer) and sintering them together or by a wet-chemical sol-gel process. The layers can be bonded together by either simple pressing of the layers and sintering them together or by a wet-chemical sol-gel process.

Vapor deposition technique: Individual thin layer is fabricated with composite material; each has slightly different composition from others to obtain slightly different CTE and the subsequent layer is sputtered directly on top of the previously sputtered adjacent layer in a specific order to form to form a Coefficient of Thermal Expansion (CTE) Adaptor material having CTE gradually varied in only one direction, which is perpendicular to the said Bonding Interfaces.

In commercially viable practice, the Coefficient of Thermal Expansion (CTE) Adaptor materials are pre-fabricated in slab form with predetermined specific thicknesses and Extremity CTE determined by material commonly found in specific industry; for example, in Optical Industry, Quartz, other ceramic glass, aluminum, stainless steel, invar and granite are common. Parts are then finally fabricated from these slabs.

Having described and disclosed my invention, I claim:

1. A mechanical assembly, comprising at least one mechanical structure, which comprises:
two bodies having different coefficients of thermal expansion;
at least one coefficient of thermal expansion adapting means that interconnects the two said bodies via two interconnecting interfaces, which are flat and parallel to each other; the coefficient of thermal expansion adapting means has coefficient of thermal expansion gradually varied in the direction perpendicular to the said interconnecting interfaces; at each interconnecting interface, the coefficient of thermal expansion directional components of the coefficient of thermal expansion adapting means match the coefficient of thermal expansion directional components of the adjacent body in all directions parallel to the interconnecting interfaces.

2. A mechanical assembly of claim 1 wherein the coefficient of thermal expansion adapting means is bonded to at least one said body at the interconnecting interface.

3. A mechanical assembly of claim 1 wherein the coefficient of thermal expansion adapting means is non-isotropic, having different values of coefficient of thermal expansion directional components.

4. A mechanical assembly of claim 3 wherein the coefficient of thermal expansion adapting means has near zero value of coefficient of thermal expansion directional component in the direction perpendicular to the said interconnecting interfaces.

5. A mechanical assembly of claim 1 wherein the coefficient of thermal expansion adapting means is made of composite material.

6. A mechanical assembly of claim 5 wherein the coefficient of thermal expansion adapting means material is made by pressing and sintering processes of solid powders.

7. A mechanical assembly of claim 5 wherein the coefficient of thermal expansion adapting means material is made by the sol-gel process.

8. A mechanical assembly of claim 1 wherein the coefficient of thermal expansion adapting means comprises multiple layers with uniform thickness, having different coefficients of thermal expansion, and are bonded together along the bonding interfaces parallel to the interconnecting interfaces in a specific order to form a composite body having coefficient of thermal expansion gradually varied in only one direction, which is perpendicular to the said bonding interfaces.

9. A mechanical assembly of claim 8 wherein the material of said multiple layers is made by pressing and sintering processes of solid powders.

10. A mechanical assembly of claim 8 wherein the material of said multiple layers is made by the sol-gel process.

11. A solid body comprising two flat outer surfaces, parallel to each other; the said body is made of material having coefficient of thermal expansion gradually varied in the direction perpendicular to the said two flat outer surfaces.

12. A solid body of claim 11 wherein the said body is made of non-isotropic material having different values of coefficient of thermal expansion directional components.

13. A solid body of claim 12 wherein the said body is made of material having near zero value of coefficient of thermal expansion directional component in the direction perpendicular to the said two flat outer surfaces.

14. A solid body of claim 11 wherein the said body is made of composite material.

15. A solid body of claim 11 wherein the said body comprises multiple layers with uniform thickness, having different coefficients of thermal expansion, and are bonded together along the bonding interfaces parallel to the said two flat outer surfaces in a specific order to form a composite body having coefficient of thermal expansion gradually varied in only one direction, which is perpendicular to the said bonding interfaces.

16. A solid body of claim 15 wherein the material of said multiple layers is fabricated by pressing and sintering processes of solid powders.

17. A solid body of claim 16 wherein the said multiple layers are bonded by pressing the layers and sintering them together.

18. A solid body of claim 15 wherein the material of said multiple layers is fabricated by the sol-gel process.

19. A solid body of claim 18 wherein the said multiple layers are bonded by the sol-gel process.

20. A solid body of claim 15 wherein multiple layers are fabricated and bonded together by sputtering process; the first layer material is sputtered onto a flat surface mold, and each subsequent layer material is sputtered directly on top of the previously sputtered adjacent layer in a specific order.
